(19) United States
(12) Patent Application Publication
(10) Pub. No.: US 2012/0084550 A1
(43) Pub. Date: Apr. 5, 2012

(54) INFORMATION PROCESSING SYSTEM AND STARTUP CONTROL METHOD

(75) Inventor: Yoshiki MIZUSAWA, Kawasaki (JP)

(73) Assignee: FUJITSU LIMITED, Kawasaki-shi (JP)

(21) Appl. No.: 13/249,986

(22) Filed: Sep. 30, 2011

(30) Foreign Application Priority Data
Oct. 4, 2010 (JP) 2010-225114

(51) Int. Cl. G06F 9/06

(52) U.S. Cl. 713/2

(57) ABSTRACT

An information processing system including a control apparatus and a housing includes a device that operates under control of the control apparatus, the control apparatus includes a memory that stores operability information including plural pieces of the operability information each indicate whether an device is operable under the control of the control apparatus, and a startup controller that obtains designation information designating a piece of the operability information from the housing and reads a piece of the operability information designated by the obtained designation information, wherein the startup controller requests the housing to start up the device when the read piece of the operability information indicate that the device is operable, and excludes the device from being subject to startup control when the read piece of the operability information indicates that the device is inoperable.

### CROSS-REFERENCE TO RELATED APPLICATION

This application is based upon and claims the benefit of priority of the prior Japanese Patent Application No. 2010-225114, filed on Oct. 4, 2010, the entire contents of which are incorporated herein by reference.

### FIELD

Embodiments of the present invention relate to an information processing system and a startup control method.

### BACKGROUND

Some types of computer systems, such as servers, are constituted by an arbitrary combination of device units on which corresponding central processing units (CPUs), memories, input/output (I/O) devices, or the like are provided. For example, there is a computer system including a large number of CPU units, for example, 64 CPU units. Such a computer system including a plurality of device units may be provided with a control apparatus for centrally controlling the device units. The control apparatus performs startup control of each device unit, monitoring of occurrence of an abnormality in each device unit, and so on.

As a technology for the computer startup control, there is a computer that is configured to generate a hash value from code of a boot loader retrieved from a nonvolatile memory, to determine whether or not the boot loader is authorized on the basis of the hash value, and to execute the boot loader only when it is authorized.

In addition, as an example of a computer to which a plurality of external devices are coupled, there is a computer that stores, upon detecting that any of the coupled external devices is a failed device, information of the failed device and that starts, in the next startup, all of the devices except the failed device detected in the previous startup, on the basis of the stored information.

Examples of technology related to such information processing apparatuses are discussed in Japanese Unexamined Patent Application Publication Nos. 2007-102791 and 2007-249761.

In such a computer system including a plurality of device units and a control apparatus, any of the pre-installed device units may be replaced with a newly released version of the device unit. There are also cases in which different versions of device units are included in a single computer.

For example, when a new version of the device unit is installed in a computer system while firmware to be executed is left unupdated, the new version of the device unit to be installed may fail to operate properly using the firmware currently executed on the computer system. When a device unit that does not operate properly exists in a computer system, the entire computer system could perform abnormally. Thus, it is desired that the computer system be configured so that the device units do not malfunction.

An object of an embodiment of the present invention is to provide an information processing system and a startup control method that prevent malfunction of electronic devices in a system.

### SUMMARY

According to an aspect of the invention, an information processing system includes a control apparatus and a housing that includes an electronic device that operates under control of the control apparatus,

the control apparatus includes

a first memory that stores an operation determination map in which a plural pieces of operability information are set, each piece of the operability information indicate whether the electronic device is operable under the control of the control apparatus, and
a startup controller that obtains, from the housing, designation information designating one of the piece of the operability information set in the operation determination map, and that reads a piece of the operability information designated by the obtained designation information;

the startup controller requests the housing from which the designation information was obtained to start up the electronic device in the housing when the read piece of the operability information indicates that the electronic device is operable, and excludes the electronic device in the housing from which the designation information was obtained from being subject to startup control when the read piece of the operability information indicates that the device is inoperable, and

the housing includes a second memory that stores the designation information designating one of the pieces of the operability of the electronic device in the housing.

The object and advantages of the invention will be realized and attained by at least the features, elements, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating the configuration of an information processing system according to a first embodiment;

FIG. 2 is a block diagram illustrating the configuration of a computer system according to a second embodiment;

FIG. 3 illustrates the hardware configuration of a management terminal;

FIG. 4 is a block diagram illustrating processing functions of a control apparatus and the configuration of one CPU unit;

FIG. 5 illustrates an operation determination map and a firmware association map;

FIG. 6 illustrates relationships between the operation determination map and the version numbers of device units and of initial setting values;

FIG. 7 illustrates relationships between the operation determination map and the version numbers of device units and of initial setting values;

FIG. 8 illustrates the states of the operation determination map and firmware association maps when one version of firmware is released;

FIG. 9 illustrates the states of the operation determination map and the firmware association maps when a new version of a CPU unit is installed in a rack;

FIG. 10 illustrates the states of the operation determination map and the firmware association maps when the firmware is updated;

FIG. 11 is a flowchart illustrating a procedure of device-unit startup processing performed by the control apparatus;

FIG. 12 illustrates multiple types of maps in a third embodiment;

FIG. 13 is a flowchart illustrating a procedure of device-unit startup processing performed by the control apparatus; and

FIG. 14 is a flowchart illustrating a procedure of combination determination processing.

### DESCRIPTION OF EMBODIMENT

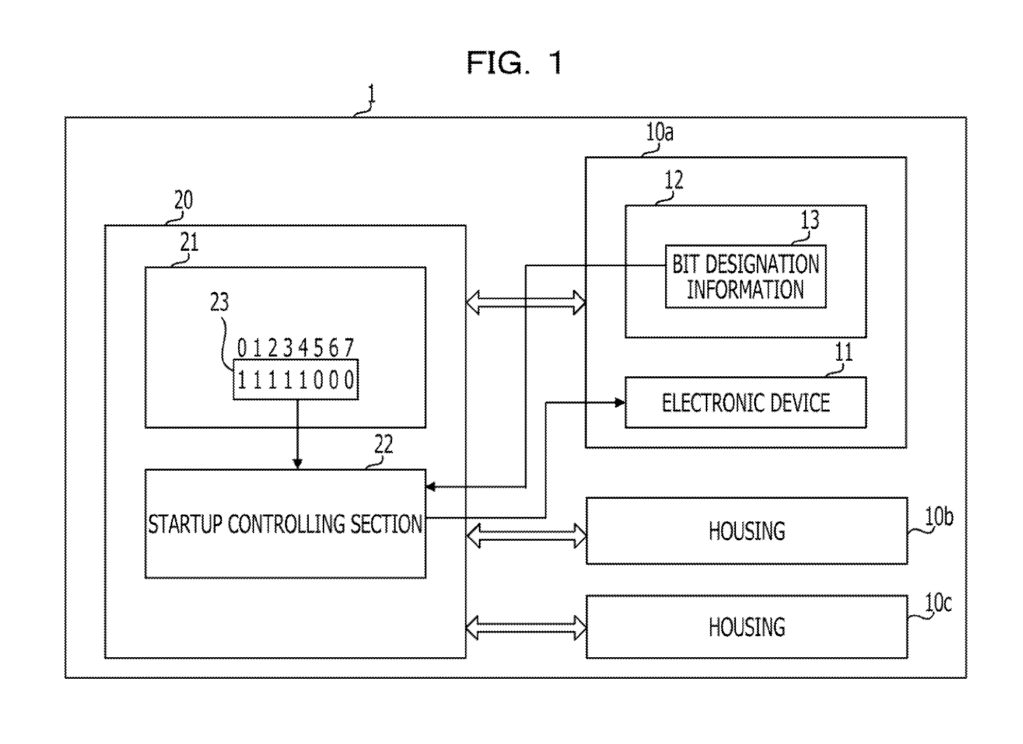

FIG. 1 is a block diagram illustrating the configuration of an information processing system according to a first embodiment.

An information processing system 1 illustrated in FIG. 1 includes a plurality of device installation units 10a, 10b, and 10c (may be referred to herein as 10) in which a device is installed therein (herein after referred to “housing”) and a control apparatus 20. Although the information processing system 1 in the example in FIG. 1 includes three housings 10a, 10b, and 10c, the number of housings included in the information processing system 1 is not limited thereto.

An electronic device 11 and a nonvolatile storage section 12 are installed in the housing 10a. Under the control of the control apparatus 20, the electronic device 11 and the nonvolatile storage section 12 are started up and operated. The electronic device 11 may be, for example, a discrete device, such as a CPU, a memory, or an I/O device, included in a computer. Alternatively, the electronic device 11 itself may be a computer. The nonvolatile storage section 12 stores bit designation information 13 described below. The nonvolatile storage section 12 installed in the housing 10a allows stored information to be accessed by the control apparatus 20, even when the electronic device 11 is not operated, for example, even when no power is supplied to the electronic device 11.

The housings 10b and 10c may have essentially the same configuration as that of the housing 10a. However, the types of electronic devices installed in the housings 10a, 10b, and 10c may be different from each other. For example, when the electronic devices installed in the housings 10a, 10b, and 10c are discrete devices constituting a computer, the electronic devices installed in the housings 10a, 10b, and 10c may operate as the computer in cooperation with each other.

The control apparatus 20 includes a nonvolatile storage section 21 and a startup controlling section 22. The nonvolatile storage section 21 stores an operation determination map 23. The startup controlling section 22 refers to the operation determination map 23, stored in the nonvolatile storage section 21, to control startup of the electronic devices installed in the housings 10a, 10b, and 10c.

The electronic-device startup control performed by the startup controlling section 22 will now be described. For starting an electronic device 11 installed in one housing 10, the startup controlling section 22 obtains the bit designation information 13 corresponding to the electronic device 11 from the housing 10. On the basis of a comparison between the bit designation information 13 and the operation determination map 23, the startup controlling section 22 determines whether or not to start up the electronic device 11 installed in the housing 10 from which the bit designation information 13 was obtained.

The operation determination map 23 has multiple bits associated with the corresponding electronic devices 11. Pieces of operability/inoperability information are set at the respective bits in the operation determination map 23. Each piece of operability/inoperability information indicates whether or not the electronic device 11 associated with the corresponding bit is operable properly under the control of the control apparatus 20. In the example in FIG. 1, the operation determination map 23 has eight bits, i.e., bit 0 to bit 7, at each of which a value “1” or “0” is set as a piece of operability/inoperability information. The bit at which the value “1” is set indicates that the electronic device 11 associated with the bit is operable properly under the control of the control apparatus 20 and the bit at which the value “0” is set indicates that the electronic device 11 associated with the bit is not operable properly under the control of the control apparatus 20.

The bit designation information 13 stored in each housing 10 is information that designates one of the bits in the operation determination map 23. That is, the bit designation information 13 indicates with which of the bits in the operation determination map 23 the electronic device 11 in the housing 10 in which the bit designation information 13 is stored is associated.

It is desired that electronic devices 11 of the same type be associated with the bits in the operation determination map 23. In this case, the operation determination map 23 is prepared for each type of the electronic devices 11 and, for controlling startup of the electronic device 11, the startup controlling section 22 refers to the operation determination map 23 corresponding to the type of the electronic device 11 to be controlled. That is, the bit designation information 13 stored in the housing 10 is information that designates, of the bits in the operation determination map 23 corresponding to the type of the electronic device 11 installed in the housing 10, one bit associated with the electronic device 11 installed in the housing 10. A description below will be given of processing when the startup controlling section 22 starts up the electronic device 11 in the housing 10a.

Prior to starting the electronic device 11, the startup controlling section 22 obtains the bit designation information 13 from the nonvolatile storage section 12 in the housing 10a in which the electronic device 11 to be started up is installed. The startup controlling section 22 reads one piece of operability/inoperability information set at, in the operation determination map 23, the bit designated by the obtained bit designation information 13. When the read piece of operability/inoperability information indicates operability, e.g., indicates that the electronic device 11 is operable, the startup controlling section 22 requests the housing 10a so as to start up the electronic device 11. On the other hand, when the read piece of operability/inoperability information indicates inoperability, e.g., indicates that the electronic device 11 is inoperable, the startup controlling section 22 excludes the electronic device 11 from the electronic devices to be started up. The startup controlling section 22 may also perform processing for notifying a user that the electronic device 11 is not operating properly, by a display or the like.

Through the startup control based on the result of the comparison between the bit designation information 13 and the operation determination map 23, the startup of the electronic device 11 that cannot be properly controlled by the control apparatus 20 is disabled. As a result, a malfunction of the electronic device 11 can be prevented and the reliability of the operation of the information processing system 1 may be improved.

The control apparatus 20 may also have a function for rewriting, of the bits in the operation determination map 23, the bit indicating inoperability so as to indicate operability. In such a case, the startup controlling section 22 updates content of the processing so that the electronic device 11 associated with the bit rewritten so as to indicate operability can be properly controlled. When the operability/inoperability information indicating inoperability, the information being set at the bit in the operation determination map 23, is rewritten so as to indicate operability, it is possible to increase the number of electronic devices 11 that can be properly controlled by the startup controlling section 22.

When a new housing is just released, there is a case in which the control apparatus 20 cannot ensure the operation of an electronic device 11 in the new housing. In such a case, one bit included in the operation determination map 23 and associated with the new electronic device 11 is set so as to indicate inoperability, to thereby make it possible to prevent the new electronic device from operating in the information processing system 1.

After the bit setting, the content of the processing of the startup controlling section 22 and the firmware stating the processing procedure of the startup controlling section 22 are updated. When the control apparatus 20 becomes able to ensure the operation of the electronic device 11 in the new housing 10, the bit included in the operation determination map 23 and associated with the new electronic device 11 is updated so as to indicate operability, to thereby make it possible to enable the new electronic device 11 to operate in the information processing system 1.

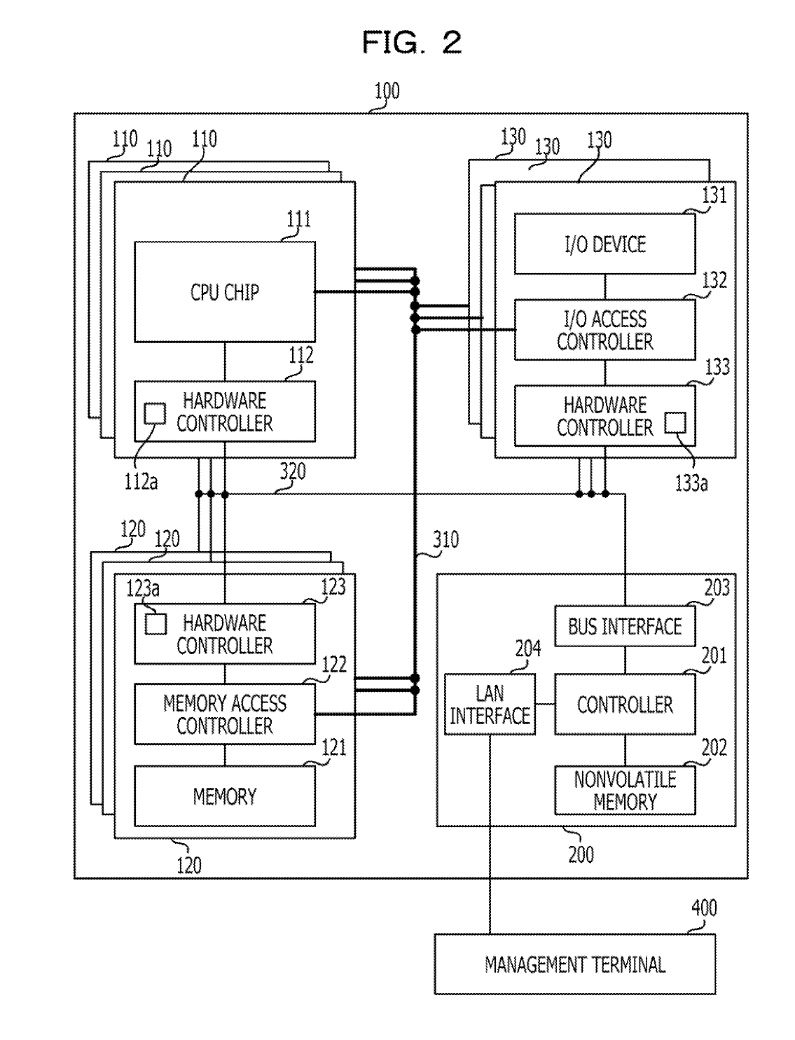

FIG. 2 is a block diagram illustrating the configuration of a computer system according to a second embodiment.

A computer system 100 illustrated in FIG. 2 includes a plurality of device units 110, 120 and 130 in which multiple types of devices constituting a computer are installed on corresponding boards. The computer system 100 illustrated in FIG. 2 includes a plurality of CPU units 110, a plurality of memory units 120, and a plurality of I/O units 130, as examples of the device units. The computer system 100 further includes a control apparatus 200 for controlling the device units.

The device units 110, 120 and 130 and the control apparatus 200 are fit into, for example, slots provided in a rack of the computer system 100. The device units 110, 120 and 130 are coupled to each other through a data bus 310 and the device units 110, 120 and 130 and the control apparatus 200 are coupled to each other through a control bus 320. The data bus 310 and the control bus 320 are provided, for example, in a backplane of the rack.

Each CPU unit 110 has a CPU chip 111 and a hardware controller 112. The CPU chip 111 is provided with a CPU, a cache module, and peripheral circuits, such as an interface circuit for the data bus 310. The CPU chip 111 starts operation, on the basis of an initial setting value (described below) set by the control apparatus 200 via the hardware controller 112.

The hardware controller 112 has a function for controlling operations of the hardware in the CPU unit 110, a function for communicating with the control apparatus 200 through the control bus 320, and so on. The hardware controller 112 has a nonvolatile memory 112a. A firmware association map (described below) is pre-stored in the nonvolatile memory 112a.

Each memory unit 120 has a memory 121, a memory access controller 122, and a hardware controller 123. The memory 121 may be implemented by a RAM (Random Access Memory) that operates as a primary storage device for the CPU(s) in one or more of the CPU units 110, for example. The memory access controller 122 may be a circuit for controlling access made from the CPU to the memory 121 through the data bus 310. The memory access controller 122 starts operation, on the basis of an initial setting value set by the control apparatus 200 via the hardware controller 123.

The hardware controller 123 includes a function for controlling operations of the hardware in the memory unit 120, a function for communicating with the control apparatus 200 through the control bus 320, and so on. The hardware controller 123 has a nonvolatile memory 123a. A firmware association map (described below) is pre-stored in the nonvolatile memory 123a.

Each I/O unit 130 has an I/O device 131, an I/O access controller 132, and a hardware controller 133. Examples of the I/O device 131 includes a nonvolatile storage device for use as a secondary storage device (such as a HDD (Hard Disk Drive)), a recording/playback device for a portable storage medium (such as an optical medium), and an interface circuit for communicating with external devices. Examples of the interface circuit for communicating with external devices include a PCI (Peripheral Component Interconnect) interface and a LAN (Local Area Network Interface). The I/O access controller 132 may be a circuit for controlling access made from the CPU to the I/O device 131 through the data bus 310.

The hardware controller 133 has a function for controlling operations of the hardware in the I/O unit 130, a function for communicating with the control apparatus 200 through the control bus 320, and so on. The hardware controller 133 has a nonvolatile memory 133a. A firmware association map (described below) is pre-stored in the nonvolatile memory 133a.

For example, when a newer device unit of the same type is supplied from the same manufacture, one of the device units included in the computer system 100 may be replaced with the new device unit. Version numbers are assigned to the device units according to their types. Device units released at later times have larger version numbers. Device units of the same type and of different versions may be included in the computer system 100. For example, a plurality of CPU units 110 whose versions are different from each other may be included in the computer system 100.

The control apparatus 200 includes a controller 201, a nonvolatile memory 202, a bus interface 203, and a LAN (Local Area Network) interface 204. The controller 201 has a CPU, a RAM, and so on therein. The CPU in the controller 201 executes firmware, stored in the nonvolatile memory 202, to control the operation of each device unit. The nonvolatile memory 202 stores, in addition to the firmware executed by the CPU in the controller 201, various data needed for execution of the firmware.

The bus interface 203 transmits/receives data to/from each device unit through the control bus 320. The LAN interface 204 transmits/receives data to/from an external management terminal 400 through a LAN cable. The management terminal 400 includes, for example, a function for requesting the control apparatus 200 to start up each device unit in the computer system 100 and a function for displaying, on a monitor, information such as warning information or the like output from the control apparatus 200.

Although not illustrated, each device unit 110, 120 and 130 includes a power-supply control circuit for supplying power to the hardware in the device unit. The power-supply control circuit in each device unit performs an operation for starting/stopping power supply, under the control of the hardware controller in the same device unit.

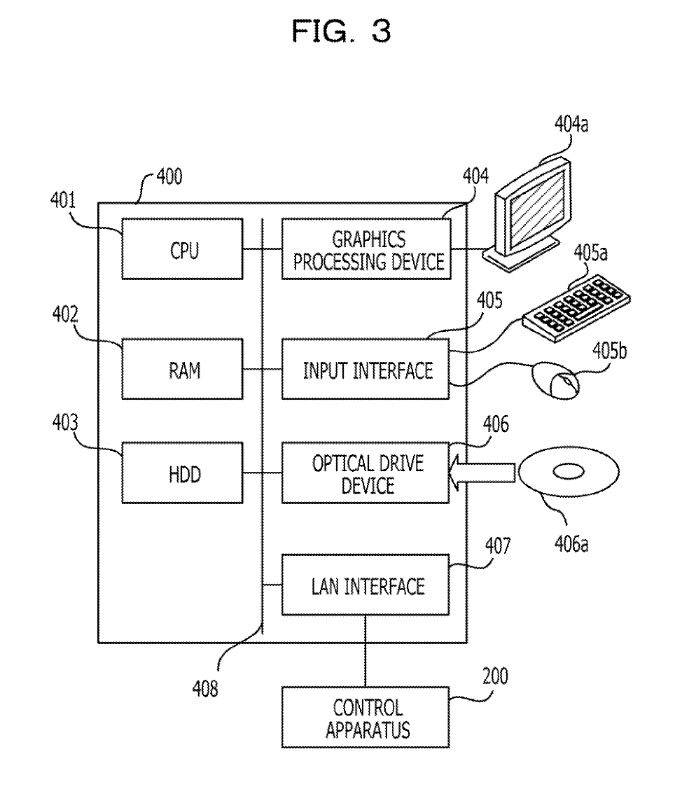

FIG. 3 illustrates the hardware configuration of the management terminal.

The management terminal 400 may be realized as a computer illustrated in FIG. 3, for example. A CPU 401 controls the entire hardware in the computer illustrated in FIG. 3. A RAM 402 and peripherals are coupled to the CPU 401 through a bus 408.

The RAM 402 may be used as a primary storage device for the computer. The RAM 402 temporarily stores at least part of a program to be executed by the CPU 401. The RAM 402 also stores various data needed for processing to be executed by the CPU 401.

Examples of the peripherals coupled to the bus 408 include an HDD 403, a graphics processing device 404, an input interface 405, an optical drive device 406, and a LAN interface 407.

The HDD 403 is used as a secondary storage device for the computer. The HDD 403 stores a program executed by the CPU 401 and various data. The secondary storage device may also be implemented by a semiconductor storage device, such as a flash memory.

A monitor 404a is coupled to the graphics processing device 404. In accordance with an instruction from the CPU 401, the graphics processing device 404 displays an image on a screen of the monitor 404a. The monitor 404a may be implemented by a liquid crystal display device, a display device using a CRT (Cathode Ray Tube), or the like.

A keyboard 405a and a mouse 405b are coupled to the input interface 405. The input interface 405 sends signals, input from the keyboard 405a and the mouse 405b, to the CPU 401. The mouse 405b is one example of a pointing device and may be implemented by another pointing device. Examples of another pointing device include a touch panel, a graphics tablet, a touchpad, and a trackball.

The optical drive device 406 uses laser light or the like to read data recorded on an optical disk 406a. The optical disk 406a is a portable recording medium to which data is recorded so as to be readable via light reflection. Examples of the optical disk 406a include a DVD (Digital Versatile Disc), a DVD-RAM, a CD-ROM (Compact Disc Read Only Memory), and a CD-R/RW (Recordable/ReWritable).

The LAN interface 407 transmits/receives data to/from the control apparatus 200 in the computer system 100 through a LAN cable.

The control apparatus 200 may be constantly supplied with power, independently of the power-supply state of each device unit. When the control apparatus 200 is supplied with power, the CPU in the controller 201 executes the firmware in the nonvolatile memory 202. When a device unit is fit into a slot in the rack of the computer system 100, the hardware controller in the device unit is powered on. The hardware controller that has been powered on starts communication with the control apparatus 200 through the control bus 320. Upon start of the communication with the hardware controller, the control apparatus 200 detects that the device unit including the hardware controller with which it is communicating is fit in the slot. Subsequently, the control apparatus 200 issues a request for processing to the hardware controller, to thereby start up the device unit including the requested hardware controller.

In response to a request from the control apparatus 200, the hardware controller starts power supply to the other hardware included in the device unit to which the hardware controller belongs. Prior to starting the power supply to the other hardware included in the device unit to which the hardware controller belongs, the hardware controller receives an initial setting value from the control apparatus 200. After starting the power supply to the other hardware included in the device unit to which the hardware controller belongs, the hardware controller sets the initial setting value, received from the control apparatus 200, for a predetermined piece of the hardware to which the power is supplied and starts up the entire device unit.

In the example in FIG. 2, after receiving an initial setting value from the control apparatus 200, the hardware controller 112 in the CPU unit 110 starts power supply to the CPU chip 111 in response to a request from the control apparatus 200. When power is supplied to the CPU chip 111, the hardware controller 112 sets the initial setting value, received from the control apparatus 200, for the CPU chip 111 and starts up the CPU chip 111. The initial setting value set for the CPU chip 111 is, for example, information specifying an operating frequency of the CPU in the CPU chip 111.

After receiving an initial setting value from the control apparatus 200, the hardware controller 123 in the memory unit 120 starts power supply to the memory 121 and the memory access controller 122 in response to a request from the control apparatus 200. When power is supplied to the memory 121 and the memory access controller 122, the hardware controller 123 sets the initial setting value, received from the control apparatus 200, for the memory access controller 122 and starts up the memory access controller 122 so that it can access to the memory 121. The initial setting value set for the memory access controller 122 is, for example, information specifying an operating frequency of the memory access controller 122.

After receiving an initial setting value from the control apparatus 200, the hardware controller 133 in the I/O unit 130 starts power supply to the I/O device 131 and the I/O access controller 132 in response to a request from the control apparatus 200. When power is supplied to the I/O device 131 and the I/O access controller 132, the hardware controller 133 sets the initial setting value, received from the control apparatus 200, for the I/O access controller 132 and starts up the entire I/O unit 130. The initial setting value set for the I/O access controller 132 is, for example, information specifying an operating frequency of the I/O access controller 132.

In the present embodiment, the hardware controller transmits the value in the firmware association map, stored in the nonvolatile memory therein, to the control apparatus 200, prior to starting up the device unit to which the hardware controller belongs. The control apparatus 200 compares the firmware-association-map value, received from the hardware controller, with the operation determination map stored in the nonvolatile memory 202. On the basis of the result of the comparison, the control apparatus 200 determines whether or not an initial setting value for enabling proper operation of the device unit from which the firmware-association-map value was transmitted is stored in the nonvolatile memory 202.

Upon determining that an initial setting value for enabling proper operation of the device unit is stored in the nonvolatile memory 202, the control apparatus 200 reads the initial setting value from the nonvolatile memory 202, transmits the read initial setting value to the hardware controller in the device unit, and causes the hardware controller to start up the device unit by using the transmitted initial setting value. On the other hand, upon determining that an initial setting value for enabling proper operation of the device unit is not stored in the nonvolatile memory 202, the control apparatus 200 does not permit startup of the device unit. By performing such startup control based on the result of the determination between the firmware association map and the operation determination map, the control apparatus 200 is adapted to prevent an initial setting value that could cause the malfunction of the device unit from being set for the device unit, thereby improving the reliability of the operation of the device unit.

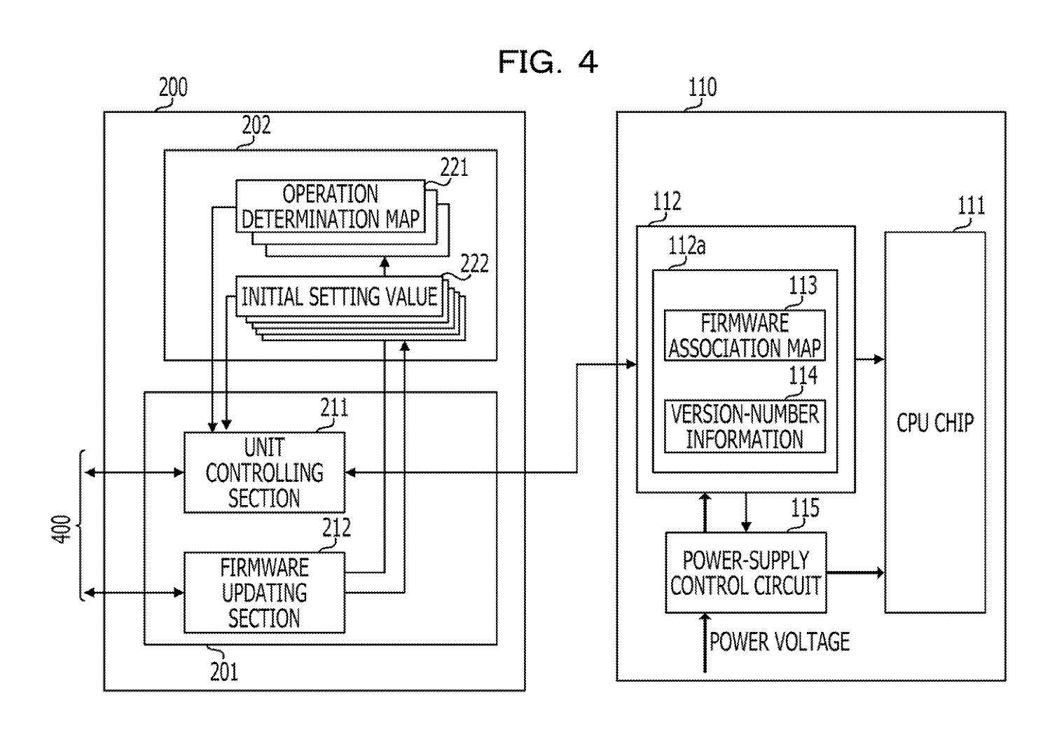

FIG. 4 illustrates an example of processing functions of the control apparatus 200 and also illustrates the configuration of one CPU unit 110 that is an example of a device unit to be controlled. FIG. 4 is a block diagram schematically illustrating functions realized by the control apparatus 200 and the CPU units 110.

The controller 201 in the control apparatus 200 has a unit controlling section 211 and a firmware updating section 212. The nonvolatile memory 202 in the control apparatus 200 stores operation determination maps 221 and initial setting values 222. The CPU (not illustrated in FIG. 4) included in the controller 201 executes unit-controlling firmware, stored in the nonvolatile memory 202, to thereby realize the processing of the unit controlling section 211 and the firmware updating section 212. The CPU may also execute individual pieces of firmware to realize the processing of the unit controlling section 211 and the processing of the firmware updating section 212. The operation determination maps 221 and the initial setting values 222 may be supplied, for example, as part of the firmware for realizing the processing of the unit controlling section 211.

The nonvolatile memory provided in the hardware controller in each device unit stores a firmware association map and version-number information indicating the version number of the device unit. For example, in the CPU unit 110 illustrated in FIG. 4, the nonvolatile memory 112a included in the hardware controller 112 stores a firmware association map 113 and version-number information 114.

Each device unit includes a power-supply control circuit, as described above. The power-supply control circuit supplies a power voltage, supplied from a shared power-supply circuit (not illustrated) in the computer system 100, to the hardware in the device unit. The power-supply control circuit constantly supplies power to the hardware controller. In response to a request from the hardware controller, the power-supply control circuit also starts power supply to, in the device unit, the hardware other than the hardware controller. In the example illustrated in FIG. 4, the CPU unit 110 includes a power-supply control circuit 115 that constantly supplies power to the hardware controller 112 and that starts a power supply to the CPU chip 111 in response to a request from the hardware controller 112.

In response to a request from the management terminal 400, the unit controlling section 211 in the control apparatus 200 controls startup processing for each device unit installed in the rack of the computer system 100. For starting up the device unit, the unit controlling section 211 first obtains the firmware association map and the version-number information from the hardware controller in the device unit.

A description below will be given of an example of processing for starting up the CPU unit 110.

The unit controlling section 211 compares the firmware association map 113 obtained from the CPU unit 110 with the operation determination map 221 read from the nonvolatile memory 202. The operation determination map 221 is prepared for each type of device unit. The unit controlling section 211 reads, from the nonvolatile memory 202, the operation determination map 221 corresponding to the type of the device unit to be controlled.

On the basis of the result of the comparison between the firmware association map 113 and the operation determination map 221, the unit controlling section 211 determines whether or not the unit controlling section 211 can properly start up the CPU unit 110 to be controlled. The expression “the unit controlling section 211 can properly start up the CPU unit 110” means that the CPU unit 110 can be properly started up by setting one of the initial setting values 222, contained in the firmware for realizing the processing of the unit controlling section 211, for the CPU unit 110.

When the unit controlling section 211 determines that the CPU unit 110 requested so as to be started up can be properly started up, the unit controlling section 211 reads the initial setting value 222 suitable for the CPU unit 110 from the nonvolatile memory 202. At least one initial setting value 222 is prepared for each type of the device unit for which it is to be set and each initial setting value 222 is given a version number for each type of the device unit. The unit controlling section 211 reads, from the nonvolatile memory 202, one of the initial setting values 222 to be set for the CPU units, the one initial setting value 222 being given a version number that is the same as or that is less than and closest to the version number indicated by the version-number information 114 obtained from the CPU unit 110 to be controlled.

The unit controlling section 211 transmits the read initial setting value 222 to the hardware controller 112 in the CPU unit 110 and issues a request to the hardware controller 112 so as to start up the entire CPU unit 110 by using the transmitted initial setting value 222. The hardware controller 112 that has received the startup request causes the power-supply control circuit 115 to start the power supply to the CPU chip 111, sets the initial setting value 222, received from the unit controlling section 211, for the CPU chip 111, and then starts up the CPU chip 111.

Upon determining that the CPU unit 110 to be controlled cannot be properly started up on the basis of the result of the comparison between the firmware association map 113 and the operation determination map 221, the unit controlling section 211 does not perform the transmission of the initial setting value 222 to the CPU unit 110 and the issuance of the startup request. The unit controlling section 211 requests the management terminal 400 so as to issue, to an operator of the management terminal 400, a notification of warning information indicating that, for example, the CPU unit 110 to be controlled cannot be properly started up and was not started up. The management terminal 400 displays the warning information on, for example, the monitor 404a.

While the processing of an example in which the management terminal 400 controls the startup of the CPU unit 110 has been described above, similar processing is also executed when another type of device unit is started up.

In response to a request from the management terminal 400, the firmware updating section 212 updates the firmware to be executed by the controller 201. The firmware updating section 212 receives a new version of the firmware from the management terminal 400 and performs firmware update processing. When operation determination maps 221 contained in the new version of the firmware have been updated, the firmware updating section 212 also updates the operation determination maps 221 stored in the nonvolatile memory 202 to the operation determination maps 221 contained in the new version of the firmware. When initial setting values 222 in the new version of the firmware have been added, the firmware updating section 212 records the added initial setting values 222 to the nonvolatile memory 202.

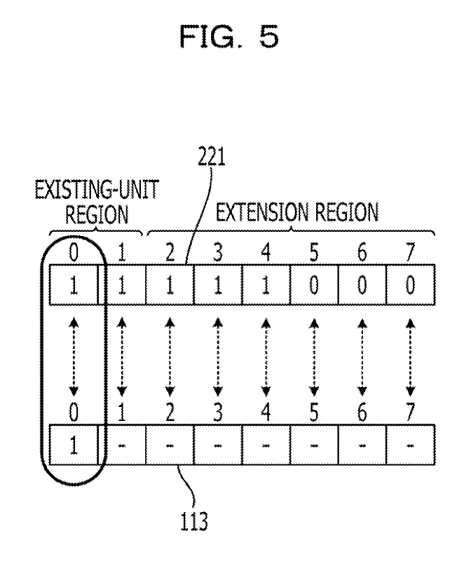

FIG. 5 illustrates the structures of the operation determination map and the firmware association map.

The operation determination map 221 is prepared for each type of device unit. In an example in which three types of device units including CPU units, memory units, and I/O units are provided, as in the example illustrated in FIG. 2, the operation determination maps 221 are prepared for the respective types of device units including the CPU units, the memory units, and the I/O units.

Multiple bits are set in each operation determination map 221. In the example in FIG. 5, information held by the operation determination map 221 is data of eight bits, i.e., bit 0 to bit 7. The bits in the operation determination map 221 are classified into bits belonging to an existing-unit region and bits belonging to an extension region. In the example in FIG. 5, bit 0 and bit 1 belong to the existing-unit region and bit 2 to bit 7 belong to the extension region. The bits belonging to the existing-unit region are associated with device units that are already available, for example, that are already released, at the time when the firmware including the operation determination map 221 is supplied. On the other hand, the extension region in the operation determination map 221 is associated with device units that will be released in the future.

The bits in the operation determination map 221 are associated with device units belonging to the same type. The value set at each of the bits in the operation determination map 221 indicates whether or not the device unit associated with the bit can be properly started up using the firmware containing the operation determination map 221. For example, it is assumed that the operation determination map 221 illustrated in FIG. 5 is contained in firmware “version 01”. When the value set at a bit is “1”, this indicates that the device unit associated with the bit can be properly started up using the firmware “version 01”. When the value set at a bit is “0”, this indicates that the device unit associated with the bit cannot be properly started up using the firmware “version 01”.

When any of initial setting values contained in the current version of firmware, for example, in the firmware “version 01” in FIG. 5, is to be used to enable startup of a device unit that will be newly released in the future, one bit in the extension region in the operation determination map 221 is reserved for the new version of the device unit and the value of the reserved bit is preset to “1”. In the example in FIG. 5, each of the values set at bit 2 to bit 4 in the operation determination map 221 is “1”. In this case, bit 2 to bit 4 are associated with CPU units that will be newly released in the future and that can be started up using any of the initial setting values contained in the firmware “version 01”.

Of the bits in the extension region, the bits at which “0” is set are associated with, of device units that will be released in the future, the device units that cannot be started up using the initial setting values included in the current version of the firmware. The bits at which “0” is set may be updated to “1” through update of the firmware. It can be said that the bits at which “0” is set are reserved for device units that will be properly started up by new initial setting information in the future. In the example in FIG. 5, the values set at bit 5 to bit 7 are “0”. Thus, the device units that cannot be started up with the firmware “version 01” are allocated to bit 5 to bit 7.

The firmware association map 113 stored in the device unit has a number of bits which is the same as the number of bits in the operation determination map 221. In the firmware association map 113, “1” is set at only one bit and no values or values “0” are written to the other bits. The bits in the firmware association map 113 correspond to the same bits in the operation determination map 221. The firmware association map 113 indicates with which of the bits in the operation determination map 221 the device unit in which the firmware association map 113 is stored is associated.

The firmware association map 113 illustrated in the FIG. 5 is stored in the CPU unit 110 “version 01”, by way of example. In the firmware association map 113 in FIG. 5, the value set at bit 0 is “1”. This indicates that the CPU unit 110 in which the firmware association map 113 is stored is associated with bit 0 in the operation determination map 221.

On the basis of the firmware association map obtained from the device unit to be controlled, the unit controlling section 211 in the control apparatus 200 recognizes which bit has a value of “1”. The unit controlling section 211 refers to, of the values at the bits in the operation determination map 221, the value at the same bit as the bit where the value is “1” in the firmware association map. When the value of the referred-to bit is “1”, the unit controlling section 211 determines that the device unit to be controlled can be properly started up using the firmware containing the operation determination map 221. When the value of the referred-to bit in the operation determination map 221 is “0”, the unit controlling section 211 determines that the device unit to be controlled cannot be properly started up using the firmware containing the operation determination map 221.

In the example in FIG. 5, since the value set at bit 0 in the firmware association map 113 is “1”, it can be known that the CPU unit 110 in which the firmware association map 113 is stored is associated with bit 0 in the operation determination map 221. Since the value set at bit 0 in the operation determination map 221 in FIG. 5 is “1”, the CPU unit 110 in which the firmware association map 113 illustrated in FIG. 5 is stored is properly started up using the firmware “version 01”.

The format of the information used by the device unit to indicate with which of the bits in the operation determination map 221 the device unit is associated is not limited to the firmware association map 113. For example, when the number of bits in the operation determination map 221 is 8, as in the example in FIG. 5, a 3-bit binary numeric number may also be used to indicate, to the control apparatus 200, with which of the bits in the operation determination map 221 the device unit is associated. In such case, a numeric value indicating that the device unit is associated with bit 0 in the operation determination map 221, as in the firmware association map 113 in FIG. 5, may be “000”. Alternatively, for example, a numeric value indicating that the device unit is associated with bit 7 in the operation determination map 221 may be “100”.

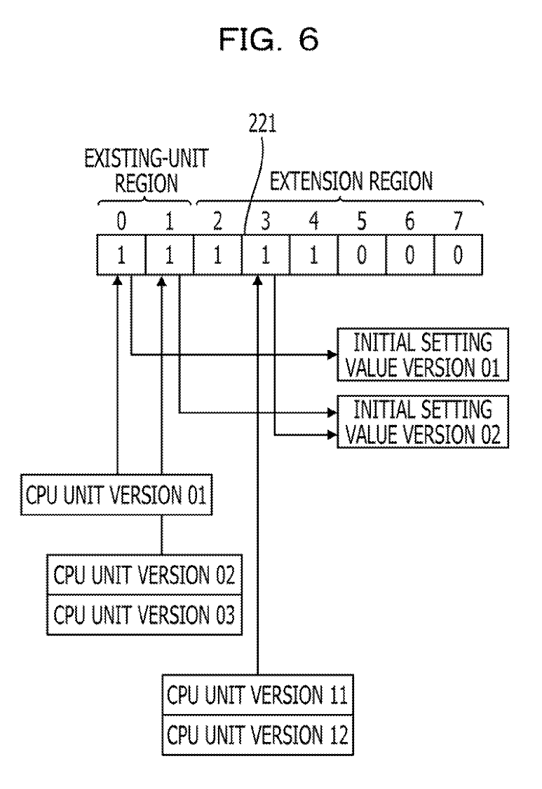

FIG. 6 illustrates one example of relationships between the operation determination map and the version numbers of device units and of initial setting values.

As described above, the device units of at least one version are associated with the bits in the operation determination map 221. For example, the firmware “version 01” is assumed to contain an initial setting value “version 01” and an initial setting value “version 02” as the initial setting values for the CPU units. It is also assumed that a CPU unit “version 01” is properly started up using the initial setting value “version 01” and both of a CPU unit “version 02” and a CPU unit “version 03” are properly started up using the initial setting value “version 02”.

As illustrated in FIG. 6, the CPU unit “version 01” may be associated with bit 0 in the operation determination map 221 and the CPU unit “version 02” and the CPU unit “version 03” may be associated with bit 1 in the operation determination map 221. In the firmware association map included in the CPU unit “version 01”, the value set at bit 0 is “1”. In this case, when the initial setting value “version 01” is associated with bit 0 in the operation determination map 221, the CPU unit “version 01” is associated with the initial setting value “version 01” via bit 0 in the operation determination map 221. In the firmware association maps included in the CPU unit “version 02” and the CPU unit “version 03”, both of the values set at bits 1 are “1”. Thus, when the initial setting value “version 02” is associated with bit 1 in the operation determination map 221, the CPU unit “version 02” and the CPU unit “version 03” are associated with the initial setting value “version 02” via bit 1 in the operation determination map 221.

Multiple versions of a device unit may also be associated with each of the bits in the extension region in the operation determination map 221. For example, both of a CPU unit “version 11” and a CPU unit “version 12” that have become available after release of the firmware “version 01” can be properly started up using the initial setting value “version 02”. In this case, the CPU unit “version 11” and the CPU unit “version 12” may be associated with, of the bits in the extension region, a bit at which “1” is set, for example, bit 3 in FIG. 6. When the initial setting value “version 02” is associated with bit 3 in the operation determination map 221, the CPU unit “version 11” and the CPU unit “version 12” are associated with the initial setting value “version 02” via bit 3 in the operation determination map 221. In this case, the CPU unit “version 11” and the CPU unit “version 12” can be properly started up without updating the firmware “version 01”.

When the association of multiple versions of a device unit with each bit in the operation determination map 221 is permitted as in the example in FIG. 6, an increase in the number of bits in the operation determination map 221 can be substantially suppressed.

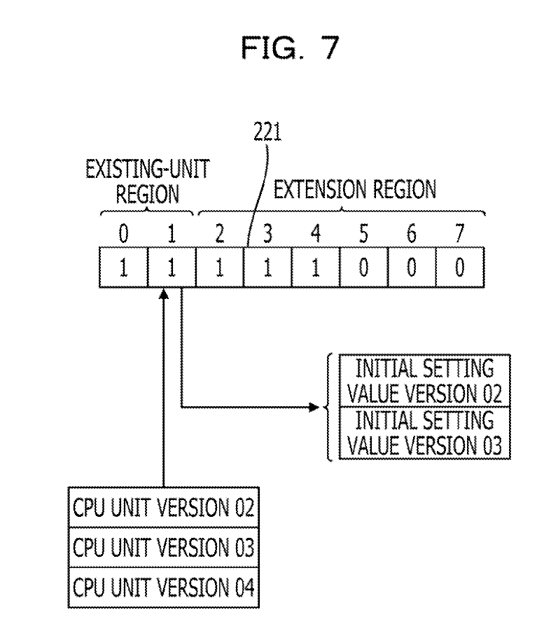

FIG. 7 illustrates another example of relationships between the operation determination map and the version numbers of device units and of initial setting values.

Although the one version of an initial setting value is associated with one bit in the operation determination map 221 in the example in FIG. 6, multiple versions of an initial setting value may also be associated with one bit in the operation determination map 221. For example, it is assumed in FIG. 7 that the CPU unit “version 02” is properly started up using the initial setting value “version 02” and both of the CPU unit “version 03” and a CPU unit “version 04” are properly started up using an initial setting value “version 03”. In this case, the CPU unit “version 02”, the CPU unit “version 03”, and the CPU unit “version 04” may also be associated with the same bit in the operation determination map 221, for example, bit 1 in FIG. 7. In this state, bit 1 in the operation determination map 221 indicates that each of the CPU unit “version 02”, the CPU unit “version 03”, and the CPU unit “version 04” can be properly started up using one of the initial setting value “version 02” and the initial setting value “version 03”. When multiple versions of an initial setting value are associated with one bit in the operation determination map 221, as described above, an increase in the number of bits in the operation determination map 221 can be substantially suppressed.

When one version of an initial setting value is associated with one bit in the operation determination map 221, as in the example in FIG. 6, the unit controlling section 211 in the control apparatus 200 can use the operation determination map 221 to determine which version of the initial setting value is to be set for a particular version of the device unit. In the example in FIG. 6, the unit controlling section 211 can determine that the initial setting value “version 02” associated with bit 1 in the operation determination map 221 may be set for the CPU unit “version 02” and the CPU unit “version 03”.

When multiple versions of an initial setting value are associated with one bit in the operation determination map 221, as in the example in FIG. 7, the unit controlling section 211 can use the operation determination map 221 to determine which version of the initial setting value is to be set for a particular version of the device unit. Accordingly, in the present embodiment, the unit controlling section 211 determines the initial setting value to be set for the device unit to be controlled, by comparing the version number indicated by the version-number information obtained from the device unit with the version number of the initial setting value. More specifically, the unit controlling section 211 sets, for the device unit, the initial setting value whose version number is the same as or is less than and closest to the version number indicated by the version-number information obtained from the device unit.

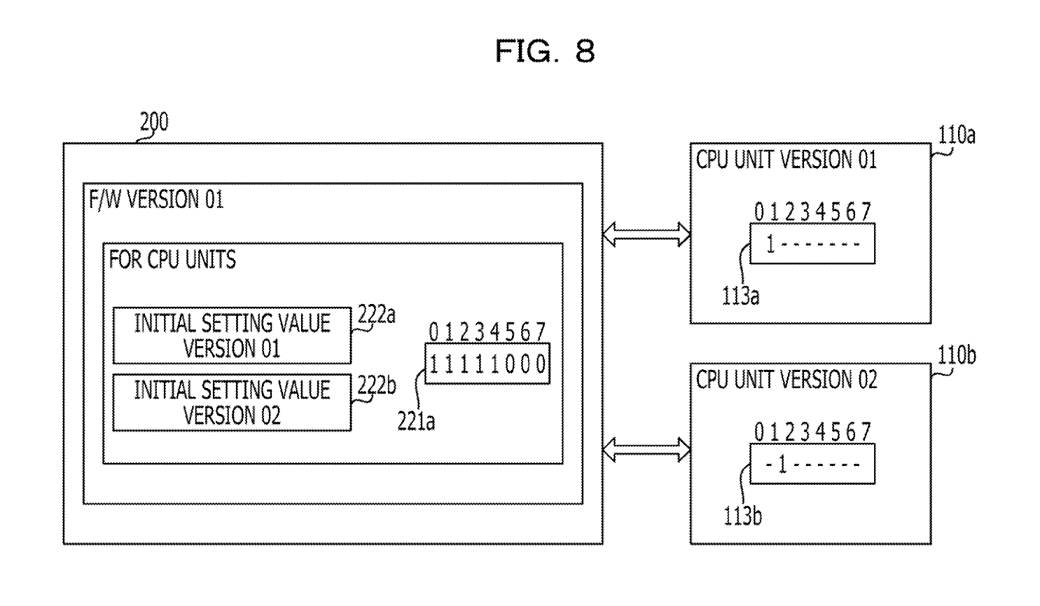

Next, a description will be given of a specific example of the determination processing that the unit controlling section 211 performs on the basis of the result of the comparison between the operation determination map and the firmware association map. FIGS. 8 to 10 illustrate processing when the startup of a CPU unit that is one example of the device unit is controlled.

FIG. 8 illustrates the states of the operation determination map and the firmware association maps when one version of firmware is released.

In the example in FIG. 8, firmware “version 01” that is executed by the controller 201 in the control apparatus 200 contains an initial setting value 222a “version 01”, an initial setting value 222b “version 02”, and an operation determination map 221a. The initial setting value 222a “version 01” enables proper startup of a CPU unit “version 01” and the initial setting value 222b “version 02” enables proper startup of a CPU unit “version 02”.

It is assumed that, in the operation determination map 221a, “1” is set at both of bits 0 and 1 in the existing-unit regions, bit 0 is associated with the CPU unit “version 01”, and bit 1 is associated with the CPU unit “version 02”. In the example in FIG. 8, “1” is set at bit 2 to bit 4 of the bits in the extension region in the operation determination map 221a. Bit 2 to bit 4 are reserved for CPU units that may be commercially available in the future and that can be started up using the firmware “version 01”. In addition, “0” is set at bit 5 to bit 7 in the extension region in the operation determination map 221a.

It is now assumed that a CPU unit 110a “version 01” and a CPU unit 110b “version 02” are installed in the rack of the computer system 100. The unit controlling section 211 in the control apparatus 200 obtains firmware association maps 113a and 113b from the respective CPU units 110a and 110b.

In the operation determination map 221a, the CPU unit “version 01” is associated with bit 0 and the CPU unit “version 02” is associated with bit 1, as described above. Thus, in the firmware association map 113a obtained from the CPU unit 110a “version 01”, “1” is set at bit 0, and in the firmware association map 113b obtained from the CPU unit 110b “version 02”, “1” is set at bit 1.

Since “1” is set at bit 0 in the firmware association map 113a obtained from the CPU unit 110a, the unit controlling section 211 in the control apparatus 200 refers to the value at bit 0 in the operation determination map 221a. Since “1” is set at bit 0 in the operation determination map 221a, the unit controlling section 211 determines that the CPU unit 110a is properly started up using the firmware “version 01”. The unit controlling section 211 transmits, to the hardware controller in the CPU unit 110a, the initial setting value 222a “version 01” that is the same as the version number of the CPU unit 110a, and also issues a request for starting up the CPU unit 110a.

Since “1” is set at bit 1 in the firmware association map 113b obtained from the CPU unit 110b, the unit controlling section 211 in the control apparatus 200 refers to the value at bit 1 in the operation determination map 221a. Since “1” is set at bit 1 in the operation determination map 221a, the unit controlling section 211 determines that the CPU unit 110b is properly started up using the firmware “version 01”. The unit controlling section 211 transmits, to the hardware controller in the CPU unit 110b, the initial setting value 222b “version 02” that is the same as the version number of the CPU unit 110b, and also issues a request for starting up the CPU unit 110b.

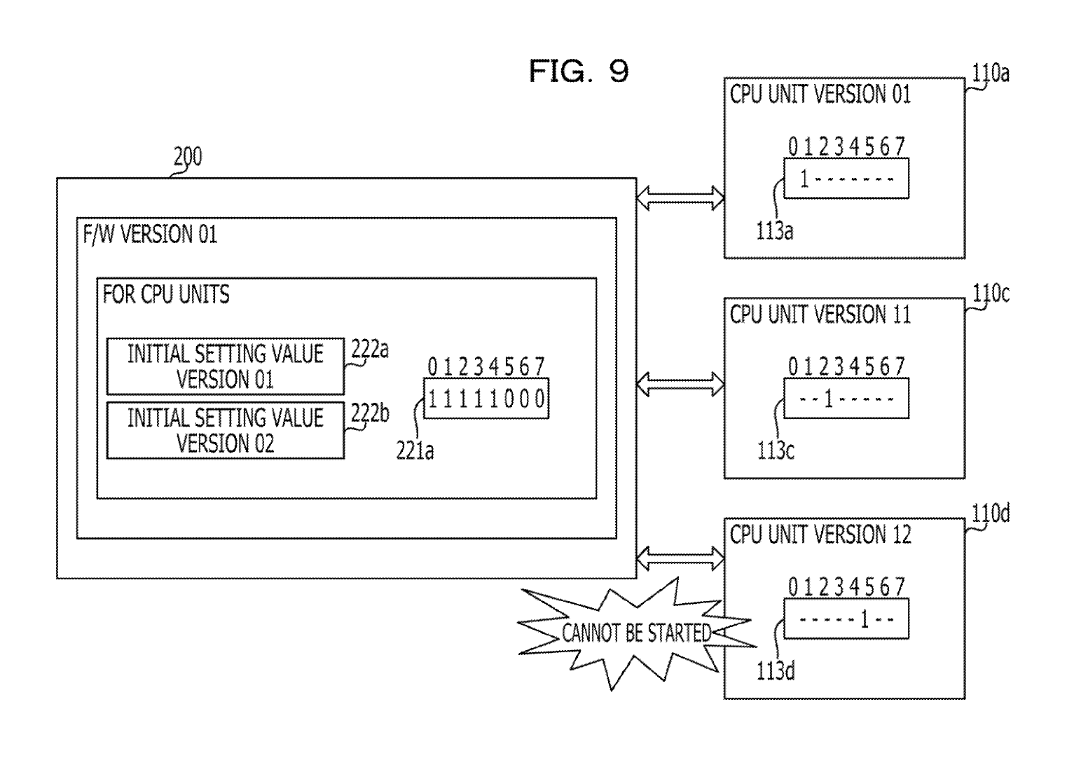

FIG. 9 illustrates the states of the operation determination map and the firmware association maps when a new version of the CPU unit is installed in the rack.

A case in which new versions 11 and 12 of a CPU unit are made commercially available after the firmware “version 01” is released will be discussed with reference to FIG. 9. It is assumed that the CPU unit “version 11” can be properly started up using the initial setting value 222b contained in the firmware “version 01” and associated with the CPU unit “version 02”. It is, however, assumed that the CPU unit “version 12” cannot be properly started up using either of the initial setting values 222a and 222b contained in the firmware “version 01”.

It is assumed that the CPU unit 110b “version 02” is removed from the rack of the computer system 100 in the state in FIG. 8 and a CPU unit 110c “version 11” and a CPU unit 110d “version 12” are installed in the rack. The unit controlling section 211 in the control apparatus 200 obtains firmware association maps 113c and 113d from the respective CPU units 110c and 110d newly installed in the rack.

The CPU unit 110c “version 11” can be properly started up using the initial setting value 222b contained in the firmware “version 01”. Thus, “1” is set at, in the firmware association map 113c included in the CPU unit 110c “version “11”, the bit corresponding to one of the bits at which “1” is set in the extension region in the operation determination map 221a. In the example in FIG. 9, “1” is set at bit 2 in the firmware association map 113c.

Since “1” is set at bit 2 in the firmware association map 113c obtained from the CPU unit 110c, the unit controlling section 211 refers to the value at bit 2 in the operation determination map 221a. Since “1” is set at bit 2 in the operation determination map 221a, the unit controlling section 211 determines that the CPU unit 110c is properly started up using the firmware “version 01”. The unit controlling section 211 transmits, to the hardware controller in the CPU unit 110c, the initial setting value 222b whose version number “02” is closest to the version number “11” of the CPU unit 110c, and also issues a request for starting up the CPU unit 110c.

On the other hand, the CPU unit 110d “version 12” cannot be properly started up using either of the initial setting values contained in the firmware “version 01”. Thus, “1” is set at, in the firmware association map 113d included in the CPU unit 110d “version “12”, the bit corresponding to one of the bits at which “0” is set in the extension region in the operation determination map 221a. In the example in FIG. 9, “1” is set at bit 5 in the firmware association map 113d.

Since “1” is set at bit 5 in the firmware association map 113d obtained from the CPU unit 110d, the unit controlling section 211 refers to the value at bit 5 in the operation determination map 221a. Since “0” is set at bit 5 in the operation determination map 221a, the unit controlling section 211 determines that the CPU unit 110d is not properly started up using the firmware “version 01”. The unit controlling section 211 thus suspends the startup processing for the CPU unit 110d and also notifies the user via the management terminal 400 that the CPU unit 110d cannot be started up when the current firmware is used. As a result, malfunction of the CPU unit 110d can be prevented and the reliability of the operation of the computer system 100 can be improved.

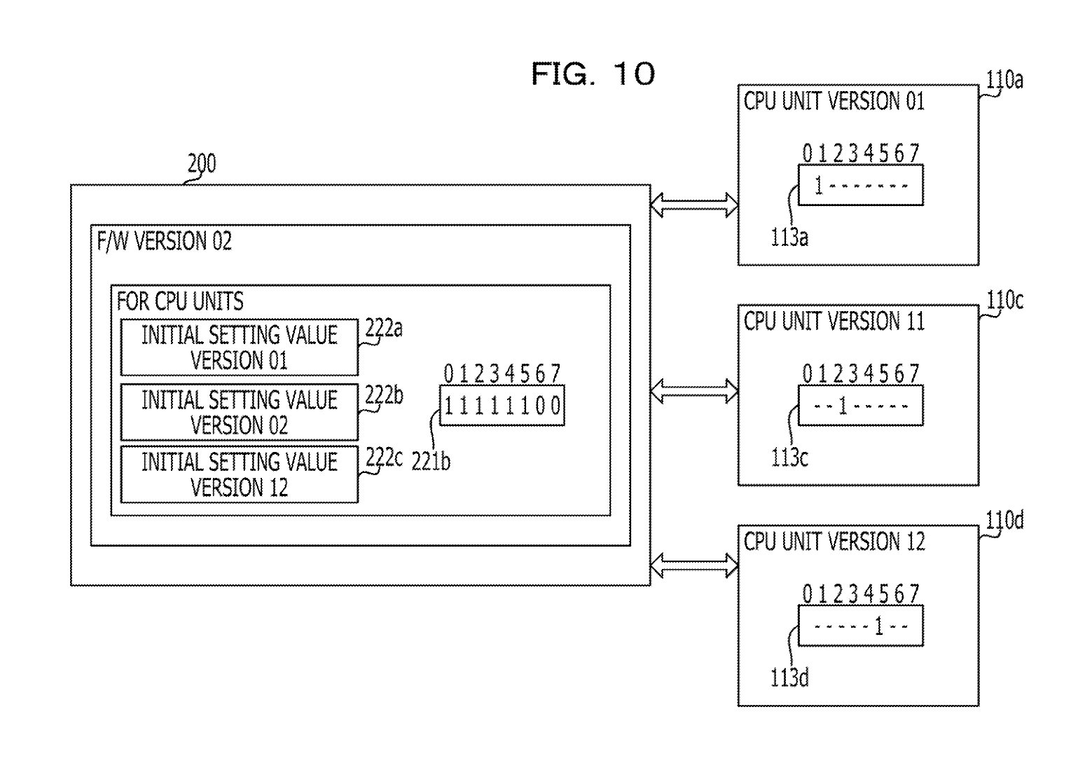

FIG. 10 illustrates the states of the operation determination map and the firmware association maps when the firmware is updated.

In this case, it is assumed that the firmware updating section 212 in the control apparatus 200 has updated the firmware in the state in FIG. 9, the firmware being executed by the controller 201 in the control apparatus 200, to firmware “version 02”. When the CPU unit “version 12” to be subjected to the startup processing is added, an initial setting value 222c that enables proper startup of the CPU unit “version 12” is added to the firmware “version 02” and the operation determination map is also updated. In an operation determination map 221b after the update, the value at bit 5, which has been associated with the CPU unit “version 12”, is changed from “0” to “1”.

After the firmware is updated, the unit controlling section 211 in the control apparatus 200 obtains the firmware association map 113d from the CPU unit 110d again. Since “1” is set at bit 5 in the firmware association map 113d obtained from the CPU unit 110d, the unit controlling section 211 refers to the value at bit 5 in the operation determination map 221b. In the state illustrated in FIG. 10, since the value at bit 5 in the operation determination map 221b has been updated to “1”, the unit controlling section 211 determines that the CPU unit 110d is properly started up using the firmware “version 12”. The unit controlling section 211 transmits, to the hardware controller in the CPU unit 110d, the initial setting value 222c corresponding to the version number of the CPU unit 110d, and also issues a request for starting up the CPU unit 110d.

Updating the bit at which “0” is set in the operation determination map to “1” in conjunction with the update of the firmware makes it possible to properly start up the device unit associated with the updated bit. This makes it possible to flexibly handle a newly released device unit, while preventing occurrence of malfunction of the device unit.

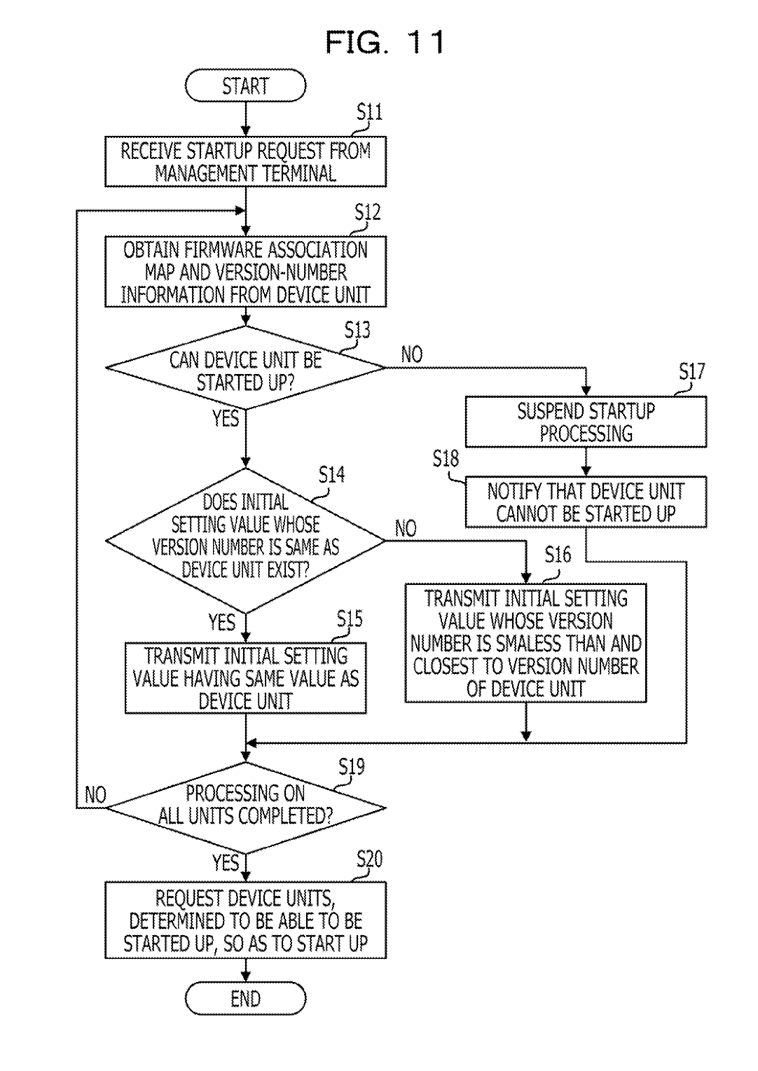

FIG. 11 is a flowchart illustrating a procedure of device-unit startup processing performed by the control apparatus.

It is assumed that, in an initial state in FIG. 11, the control apparatus 200 is powered on and the hardware controllers in all of the device units installed in the rack of the computer system 100 are also powered on. Thus, the control apparatus 200 is in a state in which it can communicate with the hardware controllers in all of the device units installed in the rack.

In operation S11, the unit controlling section 211 in the control apparatus 200 receives, from the management terminal 400, a request for starting up the computer system 100.

In operation S12, the unit controlling section 211 selects one of the device units installed in the rack and obtains the firmware association map and the version-number information of the selected device unit from the hardware controller in the device unit.

In operation S13, the unit controlling section 211 compares the firmware association map obtained in operation S12 with the operation determination map 221 corresponding to the type of the device unit selected in operation S12. On the basis of the result of the comparison between the firmware association map and the operation determination map 221, the unit controlling section 211 determines whether or not the device unit selected in operation S12 can be properly started up. The determination processing based on the result of the comparison between the firmware association map and the operation determination map 221 is substantially similar to the determination processing described above.

The computer system 100 may be provided with, for example, dedicated slots for respective types of device units. For example, the CPU unit 110 may be fit into a CPU slot, the memory unit 120 is fit into a memory slot, and the I/O unit 130 is fit into an I/O slot. The unit controlling section 211 can recognize the type of the device unit selected in operation S12, on the basis of the position of the slot in which the device unit is fit. The unit controlling section 211 may also recognize the type of the device unit, on the basis of information obtained from the device unit.

Upon determining that the device unit selected in operation S12 can be started up (Yes in operation S13) on the basis of the result of the map comparison, the unit controlling section 211 executes processing in operation S14. On the other hand, upon determining that the device unit cannot be started up (No in operation S13), the unit controlling section 211 executes processing in operation S17.

In operation S14, on the basis of the device-unit version-number information obtained in operation S12, the unit controlling section 211 determines whether or not an initial setting value whose version number is the same as the version number of the device unit exists in initial setting values corresponding to the type of the device unit selected in operation S12, the initial setting values being stored in the nonvolatile memory 202. Upon determining that an initial setting value whose version number is the same as that of the device unit exists in the nonvolatile memory 202 (Yes in operation S14), the unit controlling section 211 executes processing in operation S15. On the other hand, upon determining that an initial setting value whose version number is the same as that of the device unit does not exist in the nonvolatile memory 202 (No in operation S14), the unit controlling section 211 executes processing in operation S16.

In operation S15, the unit controlling section 211 retrieves the initial setting value having the same value as that of the device unit from the initial setting values corresponding to the type of the device unit selected in operation S12. The unit controlling section 211 transmits the retrieved initial setting value to the hardware controller in the device unit selected in operation S12. The unit controlling section 211 then executes processing in operation S19.

On the other hand, in operation S16, the unit controlling section 211 retrieves, from the initial setting values corresponding to the type of the device unit selected in operation S12, the initial setting value whose version number is less than and closest to the version number of the selected device unit. The unit controlling section 211 transmits the retrieved initial setting value to the hardware controller in the device unit selected in operation S12. The unit controlling section 211 then executes processing in operation S19.

In operation S15 or S16, the hardware controller that has received the initial setting value transmitted from the unit controlling section 211 temporarily stores the received initial setting value in the nonvolatile memory therein. Thereafter, the hardware controller monitors a startup request issued from the control apparatus 200.

When it is determined in operation S13 that the device unit cannot be started up, the process proceeds to operation S17 in which the unit controlling section 211 suspends the startup processing for the device unit selected in operation in S12. The unit controlling section 211 issues, for example, a notification for suspending the startup processing to the hardware controller in the device unit selected in operation S12.

In operation S18, the unit controlling section 211 requests the management terminal 400 so as to notify the user that the device unit selected in operation S12 cannot be started up. For example, the management terminal 400 displays, on the monitor 404a, information indicating that the device unit selected in operation S12 cannot be started up using the firmware currently executed.

Subsequently, the unit controlling section 211 executes processing in operation S19. The order of operations in S17 and S18 may be reversed.

In operation S19, the unit controlling section 211 determines whether or not the processing on all of the device units installed in the rack has been completed. When an unprocessed device unit exists (No in operation S19), the process returns to operation S12 in which the unit controlling section 211 selects another device unit and continuously performs the processing. On the other hand, when the processing has been completed on all of the device units (Yes in operation S19), the unit controlling section 211 executes processing in operation S20.

In operation S20, the unit controlling section 211 requests the hardware controllers in all of the device units, determined in operation S13 to be able to be started up, so as to start up all of the device units.

Each hardware controller that has received the startup request requests the power-supply control circuit in the device unit to which the hardware controller belongs so as to start power supply to the other hardware in the device unit. Upon start of the power supply to the other hardware in the device unit to which the hardware controller belongs, the hardware controller reads the initial setting value temporarily stored in the nonvolatile memory and sets the read initial setting value for a predetermined piece of the hardware. After the processing described above, the device-unit startup processing is completed.

According to the processing illustrated in FIG. 11, of the device units installed in the rack, only the device units that can be properly started up using the firmware executed by the control apparatus 200 are started up and the other device units are excluded from the startup control and thus are not started up. With this arrangement, malfunction of the started-up device units may be prevented and the reliability of the operation of the computer system 100 is improved.

When one initial setting value is associated with each bit in the operation determination map 221, as illustrated in FIG. 6, operations in S14 to S16 in FIG. 11 may be modified as described below.

That is, for example, the unit controlling section 211 may determine an initial setting value to be set for the device unit, on the basis of the position of the bit at which “1” is set in the firmware association map obtained in the operation S12. In this example, a table in which the bits in the operation determination map 221 are associated with the version numbers of the initial setting values may be prepared in the nonvolatile memory 202 so as to allow the unit controlling section 211 to refer to the table to determine the initial setting value to be set for the device unit. When an initial setting value to be set for each device unit is to be determined based on the position of the bit at which “1” is set in the firmware association map, the unit controlling section 211 does not need to obtain the version-number information from the device unit in operation S12.

In addition, when an initial setting value to be set for each device unit is to be determined based on the position of the bit at which “1” is set in the firmware association map, the model numbers of the device units, instead of the version numbers of the device units, may also be associated with corresponding bits in the operation determination map 221.

A third embodiment is directed to an example in which at least one of the device units in the computer system in the second embodiment further has a combination determination map. The combination determination map is stored in the nonvolatile memory in the hardware controller in the device unit. The combination determination map is used for processing for determining whether or not the device unit including the combination determination map is operable in combination with a different type of device unit.

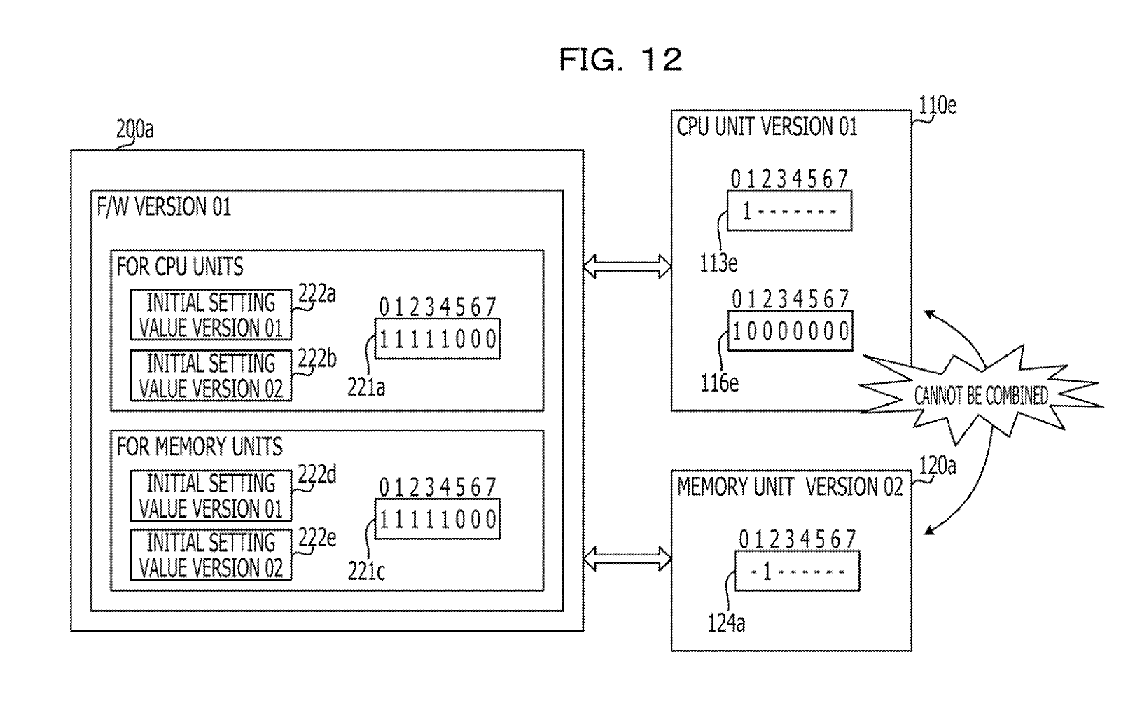

FIG. 12 illustrates a configuration using multiple types of maps in the third embodiment.

A control apparatus 200a illustrated in FIG. 12 has a function for determination processing based on the combination determination map, in addition to the configuration of the control apparatus 200 in the second embodiment described above. The nonvolatile memory (not illustrated) in the control apparatus 200a stores an operation determination map 221a used for CPU startup/non-startup determination, an initial setting value 222a “version 01” and an initial setting value 222b “version 02” which are to be set for the CPU units, an operation determination map 221c used for memory-unit startup/non-startup determination, and an initial setting value 222d “version 01” and an initial setting value 222e “version 02” which are to be set for the memory unit.

For example, a CPU unit 110e “version 01” and a memory unit 120a “version 02” are installed in the rack. The nonvolatile memory (not illustrated) in the hardware controller in the CPU unit 110e stores a firmware association map 113e and a combination determination map 116e. The nonvolatile memory (not illustrated) in the hardware controller in the memory unit 120a stores a firmware association map 124a.

When the CPU unit 110e is to be used in combination with one memory unit, the combination determination map 116e stored in the CPU unit 110e is used for the control apparatus 200a to determine whether or not the CPU unit 110e can be properly used in combination with the memory unit. A case in which the CPU unit 110e is to be used in combination with one memory unit refers to, for example, a case in which the memory in one memory unit is used as a primary storage device for the CPU in the CPU unit 110e. In the example in FIG. 12, it is assumed that the CPU unit 110e and the memory unit 120a are used in combination.

The combination determination map 116e stored in the CPU unit 110e has a number of bits which is the same as the number of bits in the firmware association map 124a included in the memory unit 120a on which a determination as to whether or not it can be used in combination is to be performed. A value indicating whether or not at least one memory unit associated with one bit can be used in combination with the CPU unit 110e is set at the corresponding bit in the combination determination map 116e. When the memory unit can be used in combination with the CPU unit 110e, “1” is set at the bit associated with the memory unit. On the other hand, when the memory unit cannot be used in combination with the CPU unit 110e, “0” is set at the bit associated with the memory unit.

For starting up the CPU unit 110e and the memory unit 120a, the control apparatus 200a obtains the firmware association maps 113e and 124a therefrom, as in the second embodiment. On the basis of a result of comparison of the operation determination map 221a and 221c with the corresponding obtained firmware association maps 113e and 124a, the control apparatus 200a determines whether or not each unit can be properly started up. In the example illustrated in FIG. 12, since “1” is set at bit 0 in the firmware association map 113e and “1” is set at bit 0 in the operation determination map 221a, the control apparatus 200a determines that the CPU unit 110e can be properly started up. Similarly, since “1” is set at bit 1 in the firmware association map 124a and “1” is set at bit 1 in the operation determination map 221c, the control apparatus 200a determines that the memory unit 120a can also be properly started up.

The control apparatus 200a further obtains the combination determination map 116e from the CPU unit 110e, compares the combination determination map 116e with the firmware association map 124a obtained from the memory unit 120a, and determines whether or not the memory unit 120a can be used in combination with the CPU unit 110e. That is, the firmware association map 124a in the memory unit 120a to be subjected to the combinability/non-combinability determination is used for both of the startup/non-startup determination of the memory unit 120a and the CPU-unit combinability/non-combinability determination.

In the example illustrated in FIG. 12, “1” is set at bit 1 in the firmware association map 124a and “0” is set at bit 1 in the combination determination map 116e. Thus, since the values at the corresponding bits 1 are different from each other, the control apparatus 200a determines that the CPU unit 110e and the memory unit 120a cannot be used in combination and, for example, suspends the startup processing for at least one of the CPU unit 110e and the memory unit 120a. The control apparatus 200a may further request the management terminal 400 so as to notify the user that the CPU unit 110e and the memory unit 120a cannot be used in combination. On the other hand, when both of the values at the corresponding bits in the firmware association map and the combination determination map are “1”, the control apparatus 200a determines that the CPU unit and the memory unit which are associated with the corresponding maps can be used in combination.

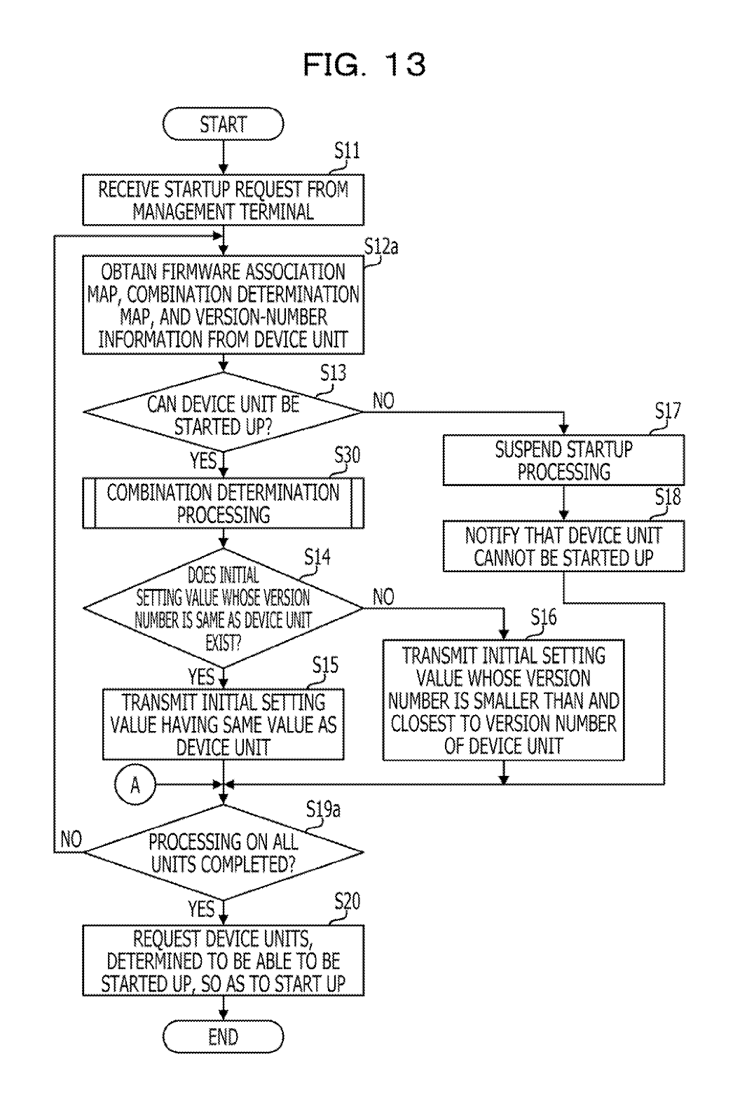

FIG. 13 is a flowchart illustrating a procedure of the device-unit startup processing performed by the control apparatus. In FIG. 13, substantially the same operations as those in FIG. 11 are denoted by the same reference numerals. In this case, it is also assumed that the configuration for the processing functions of the control apparatus 200a is substantially the same as the configuration for the processing functions of the control apparatus 200 illustrated in FIG. 4 and the determination processing based on the combination determination map is performed by the unit controlling section 211.

The processing in FIG. 13 is different from the processing in FIG. 11 in that operations in S12 and S19 in FIG. 11 are replaced with operations S12a and S19a and combination determination processing (in operation S30) is provided between operations S13 and S14.

In operation S12a, the unit controlling section 211 selects one of the device units installed in the rack and obtains the firmware association map and the version-number information from the hardware controller in the selected device unit. When a combination determination map is stored in the selected device unit, the unit controlling section 211 also obtains the combination determination map.

In operation S19a, the unit controlling section 211 determines whether or not the processing on all of the device units installed in the rack has been completed. However, with respect to the device unit(s) excluded in the combination determination processing (in operation S30 described below) from device units be started up, the unit controlling section 211 determines that the processing on those device unit(s) has been completed.

When an unprocessed device unit exists (No in operation S19a), the process returns to operation S12a in which the unit controlling section 211 selects another device unit and continuously performs the processing. On the other hand, when the processing has been completed on all of the device units (Yes in operation S19a), the unit controlling section 211 executes processing in operation S20.

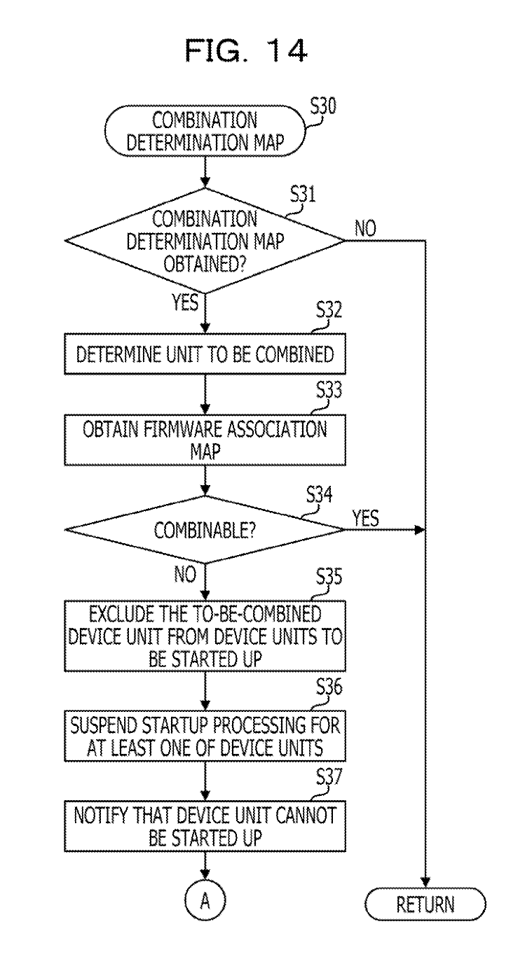

FIG. 14 is a flowchart illustrating a procedure of the combination determination processing (in operation S30).

In operation S31, the unit controlling section 211 determines whether or not a combination determination map was obtained in operation S12a in FIG. 13. Upon determining that a combination determination map was obtained (Yes in operation S31), the unit controlling section 211 executes processing in operation S32. On the other hand, upon determining that no combination determination map was obtained (No in operation S31), the unit controlling section 211 executes processing in operation S14.

In operation S32, the unit controlling section 211 determines a device unit to be combined.

The device units used in combination may be predetermined, for example, based on the positions of the slots into which the device units are fit. For example, the device units used in combination are predetermined so that the CPU unit fit in a first CPU unit and the memory unit fit in a first memory slot are used in combination and the CPU unit fit in a second CPU unit and the memory unit fit in a second memory slot are used in combination. In such a case, on the basis of the positions of the slots in which the device units that are currently processed are fit, the unit controlling section 211 can determine the device unit to be combined.

In operation S33, the unit controlling section 211 obtains a firmware association map from the hardware controller in the to-be-combined device unit determined in operation S32.

In operation S34, the unit controlling section 211 compares the firmware association map obtained in operation S33 with the combination determination map obtained in operation S12a. On the basis of the result of the map comparison, the unit controlling section 211 determines whether or not the device unit selected in operation S12a can be used in combination with the to-be-combined device unit determined in operation S32. Upon determining that these device units can be used in combination (Yes in operation S34), the unit controlling section 211 executes processing in operation S14. On the other hand, upon determining that the device units cannot be used in combination (No in operation S34), the unit controlling section 211 executes processing in operation S35.

The processing for the map comparison is performed in the following manner. The unit controlling section 211 retrieves the value set at, of the bits in the combination determination map, the bit corresponding to the bit at which “1” is set in the firmware association map. When the value retrieved from the combination determination map is “1”, the unit controlling section 211 determines that the device units can be used in combination, and when the value retrieved from the combination determination map is “0”, the unit controlling section 211 determines that the device units cannot be used in combination.

In operation S35, the unit controlling section 211 excludes the to-be-combined device unit determined in operation S32 from device units to be started up. It is determined in operation S19a that the device unit excluded from the device units to be started up has been processed.

In operation S36, the unit controlling section 211 suspends the startup processing for at least one of the device unit selected in operation S12a and the to-be-combined device unit determined in operation S32. For example, the unit controlling section 211 issues a notification for suspending the startup processing to the hardware controller(s) in the corresponding device unit(s).

In operation S37, the unit controlling section 211 requests the management terminal 400 so as to notify the user that the device unit selected in operation S12a and the to-be-combined device unit determined in operation S32 cannot be used in combination. For example, the management terminal 400 displays, on the monitor 404a, information indicating that the device units cannot be used in combination.

Next, the unit controlling section 211 executes processing in operation S19a. The order of operations in S36 and S37 may be reversed.

According to the processing illustrated in FIGS. 13 and 14, through the use of the combination determination map, startup of the device units in combination that may not be able to be properly started up is disabled. Thus, the reliability of the operation of the computer system can be improved. For example, when device units released on different dates are to be operated in combination, the later released one of the device units may not be designed for use in combination with the other earlier released device unit. According to the processing in FIGS. 13 and 14, it is possible to prevent device-unit malfunction resulting from combination of device units that are not designed for use in combination.

Since the firmware association map is used for both of the startup/non-startup determination and the combinability/non-combinability determination, the amount of information needed for the processing can be reduced and also the storage capacities of the nonvolatile memories included in the device units can be reduced.

In the processing in FIG. 14, when the combination determination map is obtained from one device unit, the firmware association map is obtained from another specific device unit to perform the processing for the combination/non-combination determination. As another example, when the unit controlling section 211 obtains the combination determination map from one device unit, the unit controlling section 211 may obtain the firmware association maps from all of the other types of the device units, installed in the rack, to determine whether or not the device unit can be used in combination with each of the device units from which the firmware association maps were obtained. In such a case, for example, type information indicating the type of each device on which the combination determination is to be performed is attached to the corresponding combination determination map. Upon obtaining the combination determination map from the device unit, the unit controlling section 211 obtains the firmware association maps from, of the device units installed in the rack, all of the device units of the type indicated by the type information attached to the obtained combination map. The unit controlling section 211 then determines whether or not the device unit can be used in combination with each of the device units from which the firmware association maps were obtained.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. An information processing system comprising:
a control apparatus; and
a housing including at least one electronic device that operates under a control of the control apparatus,
the control apparatus including:
a first memory that stores an operation determination map in which plural pieces of operability information are set, each piece of the operability information being indicative of whether the electronic device is operable under the control of the control apparatus, and
a startup controller that obtains, from the housing, designation information designating one of the pieces of the operability information set in the operation determination map, and that reads a piece of the operability information designated by the obtained designation information;
the startup controller requests the housing from which the designation information was obtained to start up the electronic device in the housing when the read piece of the operability information indicates that the electronic device is operable, and excludes the electronic device in the housing from which the designation information was obtained from being subject to startup control when the read piece of the operability information indicates that the electronic device is inoperable, and
the housing includes a second memory that stores the designation information designating at least one piece of the operability information of the electronic device in the housing.

2. The information processing system according to claim 1, wherein the control apparatus further includes an update processor that updates a piece of the operability information in the operation determination map indicating that the electronic device is inoperable so as to indicate that the electronic device is operable when the operability related to the operable information is updated.

3. The information processing system according to claim 1, wherein the first memory stores setting information to be set for the electronic device in the housing during startup, and
when a piece of the operability information designated by the obtained designation information indicates that the electronic device is operable, the startup controller transmits the setting information stored in the first memory to the housing from which the designation information was obtained, and issues a request for setting the transmitted setting information for the electronic device and for starting up the electronic device.

4. The information processing system according to claim 1, wherein the control apparatus further includes an update processor that updates, in the operation determination map, a piece of the operability information indicating that the electronic device is inoperable so as to indicate that the electronic device is operable when the operability is updated, and records, in the first memory, new setting information for enabling an operation of the electronic device.

5. The information processing system according to claim 3, wherein
the startup controller selects setting information including a version number that is the same as or less than and closest to a version number given to the housing from which the designation information was obtained when a piece of the operability information designated by the obtained designation information indicates that the associated electronic device is operable, and transmits the selected setting information to the housing from which the designation information was obtained.

6. The information processing system according to claim 3, wherein
the startup controller transmits, to the housing from which the designation information was obtained, the setting information associated with a piece of the operability information designated by the obtained designation information when the piece of the operability information designated by the obtained designation information indicates that the electronic device is operable.

7. The information processing system according to claim 1, wherein
the information processing system comprises a plurality of housings, and
the first memory stores setting information to be set for, during startup, the electronic device in any of the housings, and
the control apparatus further includes an update processor that updates a piece of the operability information in the operation determination map indicating that the electronic device is inoperable so as to indicate that the electronic device is operable, and records, in the first memory, new setting information for enabling an operation of the electronic device associated with the updated piece of the operability information so as to indicate that the electronic device is operable.

8. The information processing system according to claim 1, wherein the first memory stores the operation determination map for each type of the electronic device in the housing, and
the startup controller reads a piece of the operability information from the operation determination map corresponding to a type of the electronic device related to the designation information obtained from the housing.

9. The information processing system according to claim 8, wherein the information processing system comprises a plurality housings;
the second memory included in at least a first housing further stores a combination determination map in which combination information is set, the combination information indicating whether the electronic device in a second housing is operable in combination with the electronic device in the first housing; and
the startup controller obtains the combination determination map from the first housing, obtains the designation information from the second housing, and reads the combination information designated by the designation information obtained from the second housing,
wherein, when the read combination information indicates that the combination of the electronic device is inoperable, the startup controller excludes at least one of the electronic devices in the first housing and the electronic device in the second housing from being subject to startup control.

10. A startup control method for an information processing system including a control apparatus, and a housing includes an electronic device that operates under control of the control apparatus, the startup control method comprising:
obtaining designation information from a first memory provided in a housing, the designation information designating operability information set in an operation determination map stored in a second memory in the control apparatus, each piece of the operability information indicate whether the electronic device is operable under the control of the control apparatus;
referring to the operation determination map and reading a piece of the operability information designated by the obtained designation information; and
issuing a request for starting up the electronic device in the housing from which the designation information was obtained when the read piece of the operability information indicates that the electronic device is operable, and excluding the electronic device in the housing from which the designation information was obtained from startup control when the read piece of the operability information indicates that the electronic device is inoperable.
